(19) United States
(12) Patent Application Publication
(10) Pub. No.: US 2018/0003906 A1
(43) Pub. Date: Jan. 4, 2018

(54) COUPLING OPTICAL FIBER ARRAY WITH WAVEGUIDES OF PHOTONIC SUBASSEMBLY

(71) Applicant: Cisco Technology, Inc., San Jose, CA (US)

(72) Inventors: Ravinder KACHRU, San Jose, CA (US); Joyce PETERNEL, Morgan Hill, CA (US); Pang-Chen SUN, San Diego, CA (US)

(21) Appl. No.: 15/201,067

(22) Filed: Jul. 1, 2016

(51) Int. Cl. G02B 6/42; G02B 6/30

(52) U.S. Cl. CPC G02B 6/4227; G02B 6/4239; G02B 6/30; G02B 6/4226

(57) ABSTRACT

Disclosed are an apparatus and associated method and computer-readable medium for connecting a fiber array connector (FAC) with a photonic subassembly comprising a plurality of waveguides with a predetermined disposition relative to a top surface of a substrate. A plurality of optical fibers extend to a first surface of the FAC. The method comprises moving, using a positioning device, the FAC from a first position in which the first surface is seated against a second surface of the photonic subassembly to a second position such that the first surface has a predetermined distance from the second surface. The method further comprises performing, using the positioning device, an active alignment of the plurality of optical fibers with the plurality of waveguides, and applying, using an application device, an adhesive to form a physical interface between at least two opposing surfaces of the photonic subassembly and the FAC.

### TECHNICAL FIELD

Embodiments presented in this disclosure generally relate to aligning an optical fiber array with photonics circuitry comprising a plurality of waveguides.

### BACKGROUND

The alignment of optical components within an optical apparatus, such as optical fibers with waveguides, with sufficiently high coupling efficiency continues to be a challenge in the photonics industry. Conventional approaches to coupling optical fibers with waveguides include disposing additional optical components, such as a lens array and/or grating array, within the optical path. However, a grating array tends to be narrowband and thus unsuitable for certain high-speed applications. While a lens array provides one broadband solution, the lens array tends to add a significant cost to the optical apparatus.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an exemplary apparatus comprising a fiber array connector connected with a photonic subassembly, according to one embodiment.

FIGS. 2A and 2B illustrate movement of a fiber array connector from a first position in which a first surface of the fiber array connector is seated against a second surface of the photonic subassembly, according to one embodiment.

FIGS. 3A and 3B illustrate forming a physical interface between at least a top surface of a substrate and a first surface of the fiber array connector, according to one embodiment.

FIG. 4 illustrates forming a physical interface between a side surface of an optical component and the first surface of the fiber array connector, according to one embodiment.

FIG. 5 illustrates forming a physical interface between a side surface of a substrate and the first surface of the fiber array connector, according to one embodiment.

FIG. 6 illustrates an exemplary arrangement for connecting a fiber array connector with a photonic subassembly, according to one embodiment.

FIG. 7 is a method of connecting a fiber array connector with a photonic subassembly, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DESCRIPTION OF EXAMPLE EMBODIMENTS

### Overview

One embodiment presented in this disclosure is an apparatus. The apparatus comprises a photonic subassembly comprising a substrate defining a top surface, and at least one optical component comprising a plurality of waveguides having a predetermined disposition relative to the top surface. The apparatus further comprises a fiber array connector coupled with a plurality of optical fibers, the plurality of optical fibers extending to a first surface of the fiber array connector, and a positioning device removably coupled with the fiber array connector. The apparatus further comprises a controller comprising one or more computer processors. The controller is configured to move, using the positioning device, the fiber array connector from a first position in which the first surface is seated against a second surface of the photonic subassembly to a second position such that the first surface has a predetermined distance from the second surface. The controller is further configured to perform, using the positioning device, an active alignment of the plurality of optical fibers with the plurality of waveguides, and to apply, using an application device, an adhesive to form a physical interface between at least two opposing surfaces of the photonic subassembly and the fiber array connector.

Another embodiment is a method of connecting a fiber array connector (FAC) with a photonic subassembly, a plurality of optical fibers coupled with the FAC and extending to a first surface of the FAC, the photonic subassembly comprising at least one optical component comprising a plurality of waveguides having a predetermined disposition relative to a top surface defined by a substrate of the photonic subassembly. The method comprises moving, using a positioning device removably coupled with the FAC, the FAC from a first position in which the first surface is seated against a second surface of the photonic subassembly to a second position such that the first surface has a predetermined distance from the second surface. The method further comprises performing, using the positioning device, an active alignment of the plurality of optical fibers with the plurality of waveguides, and applying, using an application device, an adhesive to form a physical interface between at least two opposing surfaces of the photonic subassembly and the fiber array connector.

Another embodiment is a non-transitory computer-readable medium comprising computer program code that, when executed by operation of one or more computer processors, performs an operation of connecting a fiber array connector (FAC) with a photonic subassembly. A plurality of optical fibers is coupled with the FAC and extending to a first surface of the FAC, the photonic subassembly comprising at least one optical component comprising a plurality of waveguides having a predetermined disposition relative to a top surface defined by a substrate of the photonic subassembly. The operation comprises moving, using a positioning device removably coupled with the FAC, the FAC from a first position in which the first surface is seated against a second surface of the photonic subassembly to a second position such that the first surface has a predetermined distance from the second surface. The operation further comprises performing, using the positioning device, an active alignment of the plurality of optical fibers with the plurality of waveguides, and applying, using an application device, an adhesive to form a physical interface between at least two opposing surfaces of the photonic subassembly and the fiber array connector.

### EXAMPLE EMBODIMENTS

In various embodiments of an optical apparatus described herein, a fiber array connector (FAC) coupled with a plurality of optical fibers is moved to a position such that a first surface of the FAC has a predetermined distance from a second surface of a photonic subassembly comprising a plurality of waveguides. The predetermined distance can be sufficiently close to maintain a butt coupling of the optical fibers with the waveguides and/or to limit a bond line thickness required to form a physical interface between at least two opposing surfaces of the FAC and the photonic subassembly. Generally, an adhesive such as epoxy is applied between the opposing surfaces. In some cases, the adhesive is dispensed within the optical paths between the optical fibers and the waveguides.

The optical apparatus beneficially does not require grating arrays or lens arrays to couple the optical fibers with the waveguides, which reduces assembly cost and complexity. Additionally, the coupling provides a very wavelength-broadband solution for the optical apparatus. Further, the reliability of the optical apparatus may be improved, as the applied adhesive can prevent moisture or contaminants from entering cavities of the optical apparatus and thereby affecting its operation.

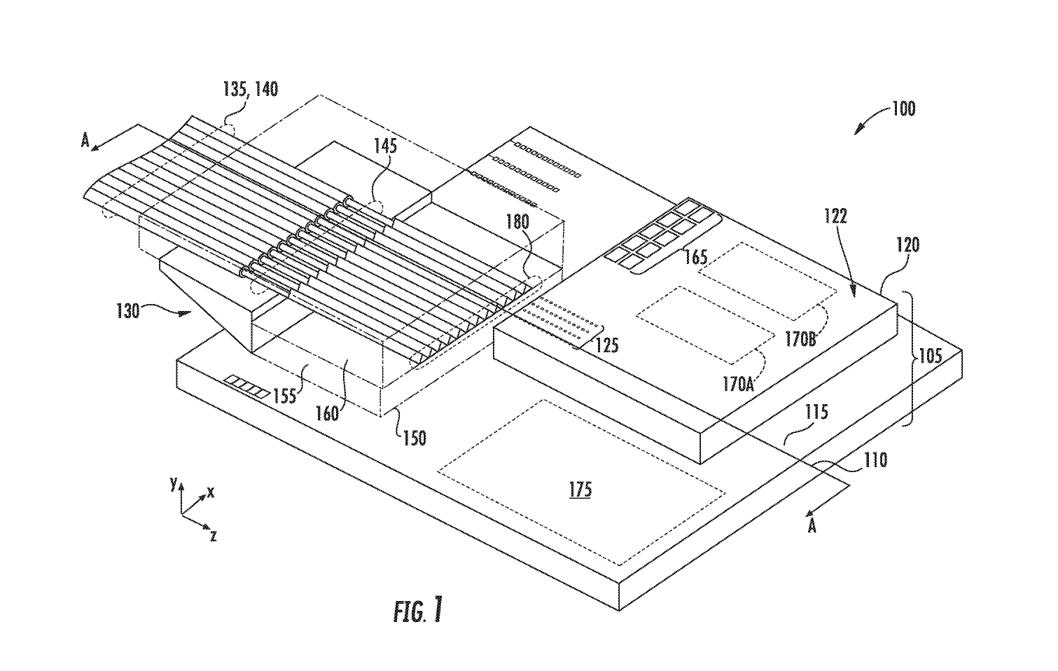

FIG. 1 illustrates an exemplary apparatus comprising a fiber array connector connected with a photonic subassembly, according to one embodiment. The apparatus 100 comprises a photonic subassembly 105 comprising a substrate 110 coupled with an optical component 120. The substrate 110 may be formed of any suitable material, such as ceramic or silicon. The substrate 110 defines a top surface 115, which is depicted as a substantially planar surface within in the X-Z plane. Alternately, the top surface 115 may have any profile suitable for coupling with the optical component 120, which may include portions extending and/or recessed from the planar surface.

As shown, the optical component 120 comprises a substrate comprising a plurality of waveguides 125. The optical component 120 may include passive and/or active elements suitable for optical communication. The positioning of the waveguides 125 within the X and Z dimensions is indicated by dashed lines along a top surface 122 of the optical component 120. However, in some embodiments the waveguides 125 are disposed beneath the top surface 122 (i.e., in the negative-Y direction). The optical component 120 is physically attached with the top surface 115 of the substrate 110 using any suitable techniques, e.g., an epoxy adhesive. After the optical component 120 is coupled with the substrate 110, the waveguides 125 have a predetermined disposition relative to the top surface 115 of the substrate 110.

As shown, the optical component 120 includes a number of conductive pads 165 configured to electrically couple with other circuitry. The optical component 120 may further include a number of areas 170A, 170B for disposing circuitry, such as openings formed into the top surface 122 of the optical component 120.

The apparatus 100 further comprises a fiber array connector (FAC) 130 coupled with a plurality of optical fibers 145. Each optical fiber 145 is part of a larger optical cable 135 comprising a number of different layers for suitable propagation of optical signals. In some embodiments, each optical cable 135 includes a center core, cladding material, buffer coating, and an insulating jacket. As used herein, the optical fibers 145 refers to the combination of the center core and cladding material portions of the optical cable 135. The optical cables 135 may have their insulating jackets and buffer coatings stripped off to expose the optical fibers 145. As shown, the optical fibers 145 extend from a jacketed portion 140 of the optical cables 135. Generally, the diameter of the optical fiber 145 for a single mode fiber may range between about 100 microns and 200 microns.

The FAC 130 comprises a base component 160 coupled with a lid component 155. The base component 160 and lid component 155 may be physically attached using any suitable means, such as an epoxy adhesive. The base component 160 and lid component 155 may be formed of any suitable material(s). In some embodiments, the materials of the base component 160 and/or lid component 155 are selected to have a comparable coefficient of thermal expansion (CTE) to the optical component 120. In this way, a maximum optical coupling can be ensured across a larger operating temperature range. In one example, the base component 160 and/or lid component 155 are formed of a borosilicate float glass having a CTE of approximately 3.25×10⁻⁶/° C., and the optical component 120 is formed of silicon having a CTE of approximately 3×10⁻⁶/° C. Some suitable alternate materials for the base component 160 and/or lid component 155 include silicon, low-expansion metal, glass, and ceramic.

In some embodiments, the base component 160 and/or lid component 155 are transmissive of ultraviolet (UV) light, such that a UV light source may transmit UV light at least partly through the FAC 130 to cure an epoxy connecting the FAC 130 with the top surface 115 of the substrate 110. For example, the base component 160 and lid component 155 may be formed of borosilicate glass. In some embodiments, the lid component 155 can be formed with tighter tolerances than the base component 160. In this case, a physical interface may be formed using a surface of the lid component 155 and the top surface 115 of the substrate 110, which aids the alignment of the optical fibers 145 with the waveguides 125.

The base component 160 and lid component 155 are configured to receive a plurality of optical fibers 145, which extend through FAC 130 to a first surface 150. Collectively, the base component 160 and lid component 155 are configured to provide the plurality of optical fibers 145 with a desired positioning and/or spacing at the first surface 150. The desired position and/or spacing of the plurality of optical fibers 145 within the FAC 130 is selected to align with the position and/or spacing of the waveguides 125 within the optical component 120. In one non-limiting example and as shown, the base component 160 defines a plurality of grooves 180, which are dimensioned to each receive a respective optical fiber 145. Each optical fiber 145 may be further secured within the respective groove 180 using, e.g., an epoxy adhesive.

In various embodiments described herein, the FAC 130 is installed to the photonic subassembly 105. A positioning device, such as a sub-micron resolution multi-stage axis system, is removably coupled with the FAC 130 and configured to move the FAC 130 relative to photonic subassembly 105. The positioning device is configured to position the FAC 130 relative to one or more surfaces of the photonic subassembly 105. Movement of the FAC 130 may be performed as part of an active alignment process, such that each optical fiber 145 is provided a suitable optical coupling with a respective waveguide 125 of the optical component 120. In some embodiments, the positioning device moves the FAC 130 to perform a butt coupling of optical fibers 145 disposed in the FAC 130 with the waveguides 125 of the optical component 120. As used herein, “butt coupling” refers to a relative disposition of the optical fibers 145 and waveguides 125 at or less than a threshold distance such that the optical coupling is suitable to meet performance requirements of the optical component 120. The butt coupling may be through free space or another material, such as an adhesive having suitable optical properties. For example, the optical component 120 may be a part of a high-speed optical modulator configured to communicate at data rates of 40 gigabits per second (Gbits/s), 100 Gbits/s, or more. In this case, one example of a suitable threshold distance is approximately 30 microns, such that the optical fibers 145 and waveguides 125 are considered “butt coupled” when disposed at a distance less than 30 microns. Additionally, it may also be beneficial to limit a bond line thickness for adhesive dispensed between the FAC 130 and the photonic subassembly 105 to ensure sufficient mechanical integrity remains within the butt coupled components, as well as to prevent air voids forming within the adhesive.

As shown, the waveguides 125 of optical component 120 are configured to align with select ones of the optical fibers 145. In some embodiment, the apparatus 100 may include one or more additional optical components (not shown), e.g., disposed at area 175 of the substrate 110. The additional optical components are configured to align with other ones of the optical fibers 145. For example, the optical component 120 comprises a receiver module and the additional optical component disposed at area 175 comprises a transmitter module.

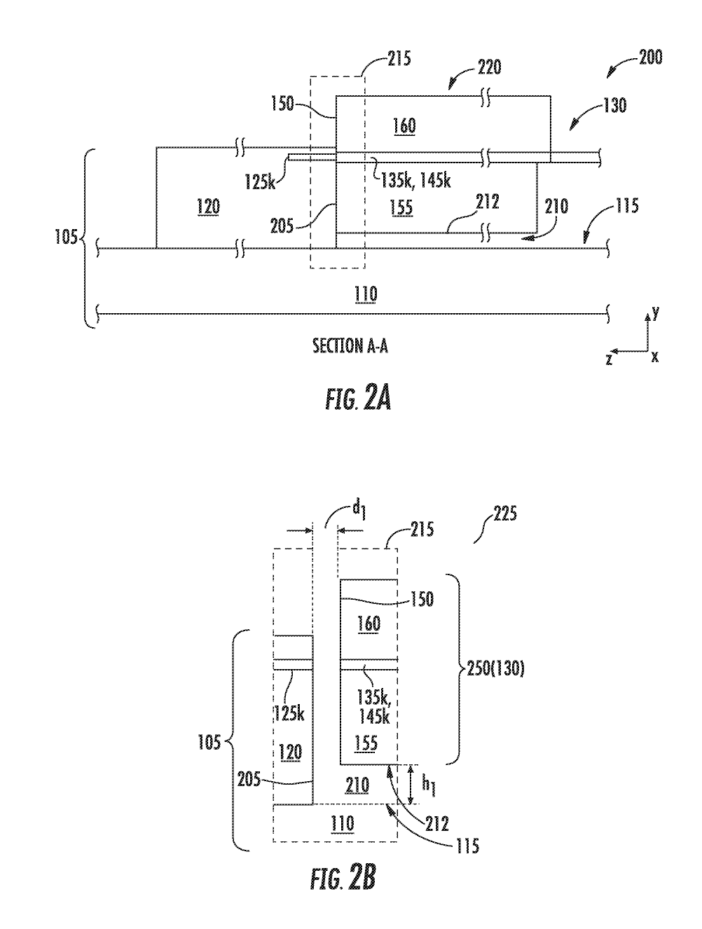

FIGS. 2A and 2B illustrate movement of a fiber array connector from a first position in which a first surface of the fiber array connector is seated against a second surface of the photonic subassembly, according to one embodiment. Generally, the fiber array connector may be the FAC 130 depicted in FIG. 1, and is removably coupled with a positioning device (not shown for clarity).

FIG. 2A depicts a cross-sectional view 200 along section A-A of apparatus 100 (FIG. 1). Within view 200, the FAC 130 is disposed at a first position 220, e.g., as positioned by a positioning device. A waveguide 125ₖ within optical component 120 is intended to be aligned with an optical fiber 145ₖ of the optical cable 135ₖ. The optical fiber 145ₖ extends to a first surface 150 of the FAC 130. At the first position 220, the first surface 150 of the FAC 130 is seated (e.g., physically coupled along the X-Y plane) against a second surface 205 of the photonic subassembly 105. As shown, the second surface 205 is a side surface of the optical component 120. An air gap 210 is defined between a bottom surface 212 of the FAC 130 and the top surface 115 of the substrate 110.

FIG. 2B depicts a cross-sectional view 225 along section A-A of apparatus 100, and specifically of section 215. Within view 225, the FAC 130 is disposed at a second position 230, e.g., when moved by a positioning device from the first position 220. At the second position 230, the first surface 150 of the FAC is disposed at a predetermined distance d₁ from the second surface 205, and the bottom surface 212 at a height h₁ from the top surface 115 of substrate 110. The predetermined distance d₁ and/or the height h₁ may be selected such that the positioning device, during a subsequent active alignment of the optical fiber 145ₖ with the waveguide 125ₖ, has sufficient freedom to displace and/or rotate the FAC 130 along multiple degrees of freedom. Additionally, the predetermined distance d₁ and/or the height h₁ may be selected sufficiently close to maintain the butt coupling of the optical fiber 145ₖ with the waveguide 125ₖ, and/or to limit a bond line thickness required to form a physical interface between surfaces of the FAC 130 and the photonic subassembly 105. In one non-limiting example, the value of the predetermined distance d₁ is between about 10 microns and 20 microns. At the second position 230, the air gap 210 further extends between the first surface 150 and the second surface 205.

In some embodiments, it may be less expensive and/or less complex to control dimensions of the lid component 155, when compared with the base component 160 having the plurality of grooves 180 formed therein. Thus, using the well-controlled lid component 155 to form a physical interface with the photonic subassembly 105 ensures that a bond line thickness for the applied adhesive remains within a desired range, as well as avoiding uneven application of the adhesive and/or air voids.

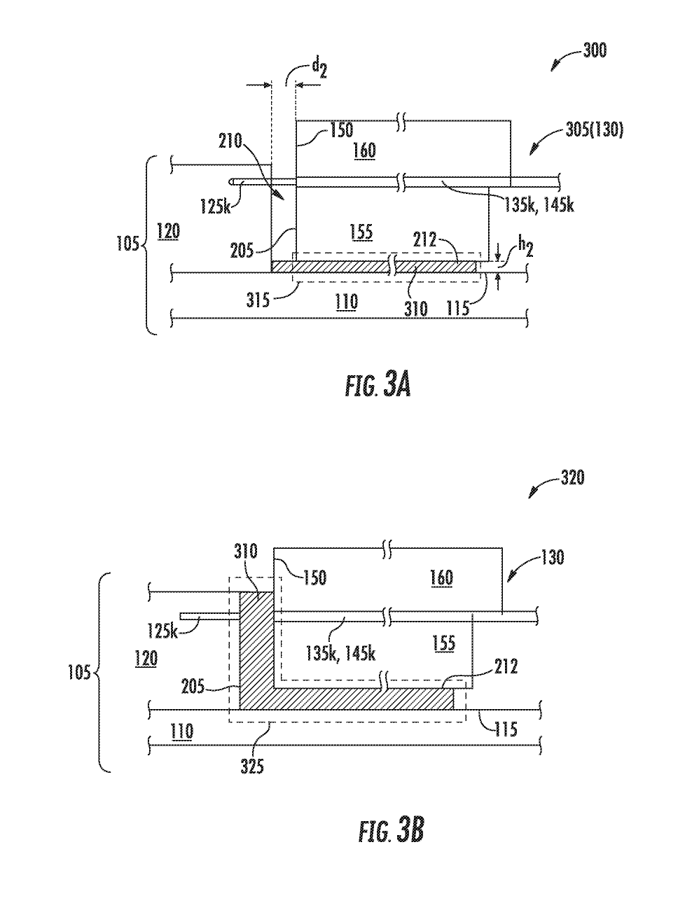

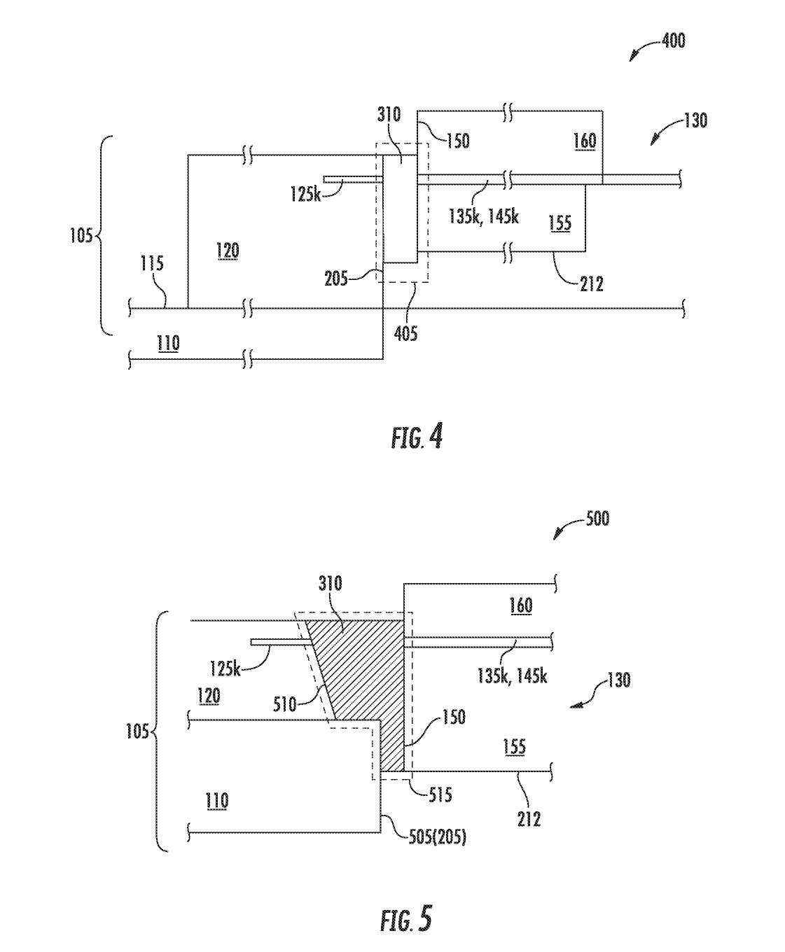

FIGS. 3A and 3B illustrate forming a physical interface between at least a top surface of a substrate and a first surface of the fiber array connector, according to one embodiment. Generally, view 300 depicts the FAC 130 at a third position 305, at which the first surface 150 and second surface 205 are separated by a distance d₂, and the bottom surface 212 and top surface 115 are separated by a height h₂. In some embodiments, the FAC 130 is moved into the third position 305 by the positioning device after performing a first active alignment process of the optical fiber 145ₖ with the waveguide 125ₖ.

An application device (not shown) applies an adhesive 310 to form a physical interface 315 between at least two opposing surfaces of the photonic subassembly 105 and the fiber array connector 130. In the embodiment shown in FIG. 3A, the physical interface 315 is formed between a bottom surface 212 of the FAC 130 and the top surface 115 of the substrate 110. The application device may have any suitable form for dispensing a desired adhesive 310. Within the embodiment depicted in view 300, the adhesive 310 may have any suitable optical properties, as the optical coupling between waveguide 125ₖ and optical fiber 145ₖ occurs across the air gap 210.

In some cases, the application of the adhesive 310 can alter positioning of the FAC 130 from the third position 305, which can reduce an optical coupling between waveguide 125ₖ and optical fiber 145ₖ across the air gap 210. Therefore, in some embodiments, a second active alignment is performed between optical fiber 145ₖ and waveguide 125ₖ after application of the adhesive 310.

In view 320 of FIG. 3B, the physical interface 325 is formed between the bottom surface 212 of the FAC 130 and the top surface 115 of the substrate 110, as well as between the first surface 150 and the second surface 205. In such an embodiment, the adhesive 310 has substantially a same optical index as the waveguide 125ₖ and/or the optical fiber 135ₖ. As with the view 300, in some embodiments a second active alignment is performed between optical fiber 145ₖ and waveguide 125ₖ after application of the adhesive 310.

Following application of the adhesive 310 within the views 300, 320, the adhesive 310 is cured to fasten the FAC 130 with the photonic subassembly 105 at the physical interface 315, 325. Any suitable method for curing the adhesive 310 may be used, such as an application of heat, chemicals, or light to the dispensed adhesive 310. In some embodiments, the curing is performed using a curing device (not shown). One non-limiting example of a curing device is an ultraviolet (UV) light source. In this case, the FAC 130 is transmissive of UV light, and the UV light source is configured to transmit UV light at least partially through the FAC 130 to cure the adhesive 310.

In the embodiment depicted in view 300, the physical interface 315 is connected with a relatively large area of the top surface 115 of the substrate 110 and provides a relatively good bond strength. The optical coupling between the optical fiber 145ₖ and waveguide 125ₖ may be slightly reduced due to optical signals crossing the air gap 210. However, within the physical interface 325 of view 320, including adhesive 310 (e.g., an epoxy having a similar optical index) in the optical path between the optical fiber 145ₖ and waveguide 125ₖ may provide improved optical coupling. Additionally, including adhesive 310 in the optical path may eliminate the need to angle the FAC 130 or angle cleave the optical fibers. However, it may be more difficult to apply the adhesive uniformly for the portion of physical interface 325 between the first surface 150 and second surface 205, and the portion between the bottom surface 212 and top surface 115.

FIG. 4 illustrates forming a physical interface between a side surface of an optical component and the first surface of the fiber array connector, according to one embodiment. In some embodiments, the FAC 130 may be moved to the position depicted in view 400 from an initial position in which the first surface 150 is seated against the second surface 205 of the optical component 120, e.g., according to the various techniques discussed above with respect to FIGS. 2 and 3. Within view 400, the substrate 110 does not extend beyond the second surface 205 of the optical component 120 and/or underneath the bottom surface 212 of the FAC 130. In one embodiment, the first surface 150 contacts only a side surface of the optical component 120 in the initial position. In another embodiment, the first surface 150 contacts a side surface of the substrate 110 in the initial position, in addition to the side surface of the optical component 120.

The adhesive 310 is applied between the first surface 150 and the second surface 205 to form a physical interface 405. In one alternate embodiment, the substrate 110 extends beyond the second surface 205 and/or underneath the bottom surface 212, but the physical interface 405 does not extend between the substrate 110 and the FAC 130 (e.g., adhesive is not applied).

FIG. 5 illustrates forming a physical interface between a side surface of a substrate and the first surface of the fiber array connector, according to one embodiment. In some embodiments, the FAC 130 may be moved to the position depicted in view 500 from an initial position in which the first surface 150 is seated against a side surface 505 of the substrate 110, e.g., the second surface 205 of the photonic subassembly 105.

As shown, a side surface 510 of the optical component 120 is not co-planar with the side surface 505 of the substrate 110. In some embodiments, the optical component 120 is formed using non-precision etching techniques, such that the side surface 510 is not substantially vertical (as shown, within the X-Y plane). For example, the optical component 120 may comprise a silica substrate or another suitable material.

In some embodiments, and as shown, the side surface 510 of the optical component 120 is disposed away from the side surface 505. In one non-limiting example, the side surface 510 is disposed at a distance of approximately 5 microns±5 microns from the side surface 505 (i.e., a range of 0<d approximately 10 microns).

The adhesive 310 is applied between at least the side surface 505 and the first surface 150 to form a physical interface 515. As shown, the adhesive 310 is also applied between the side surface 510 and the first surface 150. In such an embodiment, the adhesive 310 has substantially a same optical index as the waveguide 125ₖ and/or the optical fiber 135ₖ.

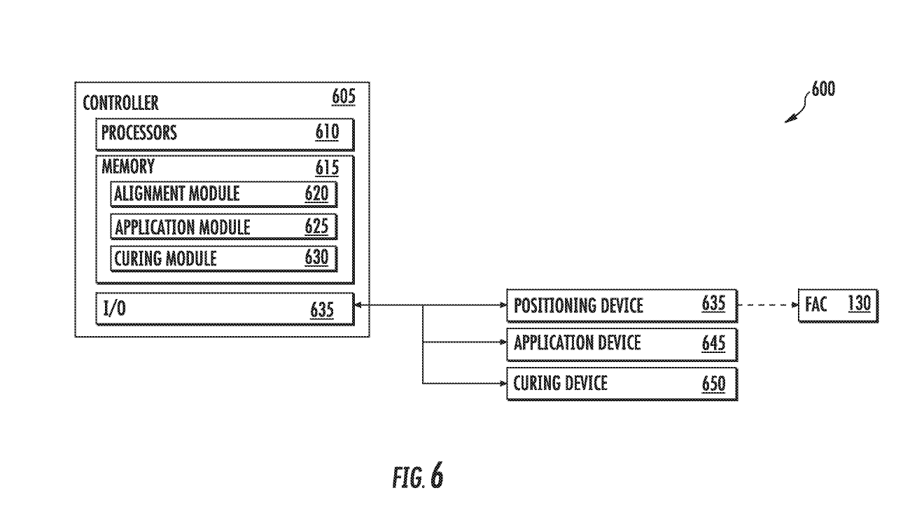

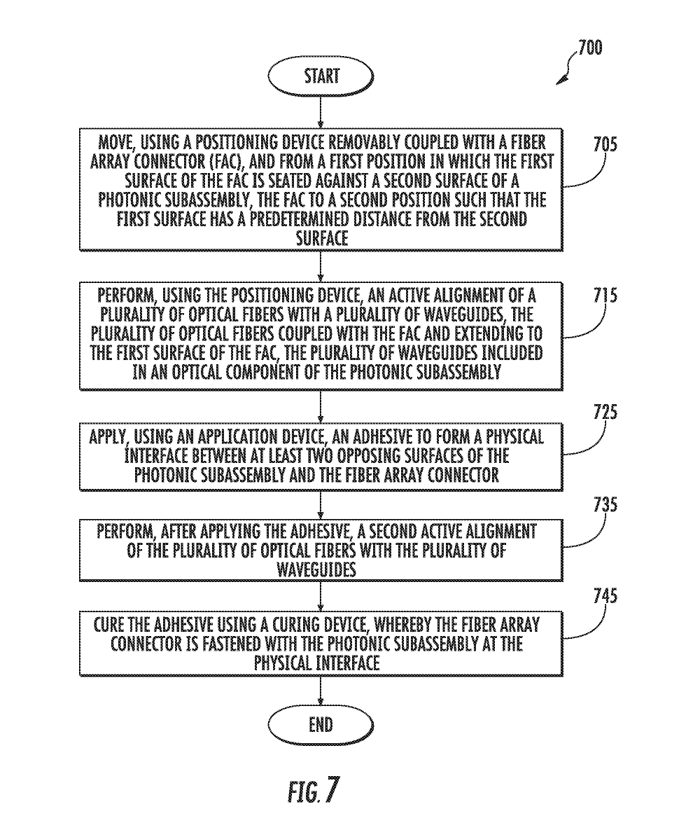

FIG. 6 illustrates an exemplary arrangement for connecting a fiber array connector with a photonic subassembly, according to one embodiment. The arrangement 600 is meant to be used in conjunction with various embodiments of the fiber array connector and photonic subassembly discussed herein.

Within arrangement 600, a controller 605 comprises one or more computer processors 610, a memory 615, and input/output (I/O) 635. The processors 610 generally retrieve and execute programming instructions stored in the memory 615. Processors 610 are included to be representative of a single central processing unit (CPU), multiple CPUs, a single CPU having multiple processing cores, graphics processing units (GPUs) having multiple execution paths, and the like. The memory 615 is generally included to be representative of a random access memory, but may further include non-volatile storage of any suitable type(s).

The I/O 635 generally provides one or more interfaces for the processors 610 to communicate signals comprising instructions and/or data with one or more I/O devices. As shown, arrangement 600 includes a plurality of I/O devices: a positioning device 640 configured to removably couple with and move the fiber array connector (FAC) 130, an application device 645 configured to apply an adhesive to form a physical interface between at least two opposing surfaces of the photonic subassembly and the fiber array connector, and a curing device 650 configured to cure the dispensed adhesive to thereby fasten the fiber array connector with the photonic subassembly.

Memory 615 generally includes program code for performing various functions related to assembling (e.g., positioning and attaching elements) and/or testing the apparatus. The program code is generally described as various functional “modules” within memory 615, although alternate implementations may include different functions and/or combinations of functions.

An alignment module 620 is configured to communicate signals with the positioning device 640, e.g., to perform movement of the positioning device 640 and/or the FAC 130, coupling and decoupling with the FAC 130, and so forth. An application module 625 is configured to communicate signals with the application device 645, e.g., to perform movement of the application device 645, dispensing a desired amount of adhesive, and so forth. A curing module 630 is configured to communicate signals with the curing device 650, e.g., to perform movement of the curing device 650, curing the adhesive according to desired physical parameters, and so forth.

FIG. 7 is a method of connecting a fiber array connector with a photonic subassembly, according to one embodiment. Method 700 is meant to be used in conjunction with various embodiments of the fiber array connector, photonic subassembly, and controller discussed herein. For example, the operation of various I/O devices may be controlled using signals provided by the controller.

Method 700 begins at block 705, where a positioning device removably coupled with the FAC moves the FAC, from a first position in which a first surface of the FAC is seated against a second surface of the photonic subassembly, to a second position such that the first surface has a predetermined distance from the second surface. In some embodiments, the second surface of the photonic subassembly comprises a side surface of one or both of a substrate and an optical component connected with the substrate. In some embodiments, the predetermined distance is selected to be sufficiently large to accommodate a subsequently active alignment process and/or an application of adhesive to form a physical interface between the photonic subassembly and the FAC.

At block 715, a positioning device performs an active alignment of a plurality of optical fibers with a plurality of waveguides, wherein the plurality of optical fibers are coupled with the FAC and extend to the first surface of the FAC. The plurality of waveguides are included in an optical component of the photonic subassembly.

At block 725, an application device applies an adhesive to form a physical interface between at least two opposing surfaces of the photonic subassembly and the fiber array connector. In some embodiments, the physical interface connects a top surface of a substrate of the photonic subassembly and a bottom surface of the FAC. In some embodiments, the physical interface additionally or alternately connects the first and second surfaces. At an optional block 735, a second active alignment of the plurality of optical fibers with the plurality of waveguides is performed after applying the adhesive. The second active alignment may help mitigate losses in optical coupling resulting from relative movement of the FAC and photonic subassembly occurring during application of the adhesive.

At block 745, the adhesive is cured using a curing device, whereby the fiber array connector is fastened with the photonic subassembly at the physical interface. In some embodiments, the curing device is an ultraviolet (UV) light source, and the FAC is substantially transmissive of UV light. Method 700 ends following completion of block 745.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium is any tangible medium that can contain, or store a program for use by or in connection with an instruction execution system, apparatus or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In view of the foregoing, the scope of the present disclosure is determined by the claims that follow.

1. An apparatus, comprising:
a photonic subassembly comprising:
a substrate defining a top surface, and
at least one optical component comprising a plurality of waveguides having a predetermined disposition relative to the top surface;
a fiber array connector coupled with a plurality of optical fibers, the plurality of optical fibers extending to a first surface of the fiber array connector;
a positioning device removably coupled with the fiber array connector; and
a controller comprising one or more computer processors and configured to:
move, using the positioning device, the fiber array connector from a first position, in which the first surface is seated against a second surface of the photonic subassembly, to a second position such that the first surface has a predetermined distance from the second surface, wherein in the second position the fiber array connector is not connected with the photonic subassembly, and wherein an air gap is defined between the top surface of the substrate and a bottom surface of the fiber array connector,
perform, responsive to moving the fiber array connector to the second position, an active alignment of the plurality of optical fibers with the plurality of waveguides, and
apply, using an application device, an adhesive to form a physical interface between at least two opposing surfaces of the photonic subassembly and the fiber array connector to thereby connect the photonic subassembly with the fiber array connector, wherein the physical interface extends at least partly into the air gap.

2. The apparatus of claim 1, wherein the controller is further configured to:
perform, after applying the adhesive, a second active alignment of the plurality of optical fibers with the plurality of waveguides.

3. The apparatus of claim 1, wherein the controller is further configured to:
cure the adhesive using a curing device, whereby the fiber array connector is fastened with the photonic subassembly at the physical interface.

4. The apparatus of claim 3, wherein the fiber array connector is transmissive of ultraviolet (UV) light, wherein the curing device comprises an UV light source configured to transmit UV light at least partially through the fiber array connector.

5. The apparatus of claim 1, wherein the fiber array connector comprises:
a base component defining a plurality of grooves, wherein each optical fiber of the plurality of optical fibers is disposed within a respective groove of the plurality of grooves; and
a lid component coupled with the base component and disposed opposite the plurality of grooves relative to the plurality of optical fibers,
wherein the first surface of the fiber array connector is formed of respective surfaces of the lid component and base component.

6. The apparatus of claim 1, wherein the second surface comprises one of a side surface of the optical component and a side surface of the substrate.

7-8. (canceled)

9. A method of connecting a fiber array connector (FAC) with a photonic subassembly, a plurality of optical fibers coupled with the FAC and extending to a first surface of the FAC, the photonic subassembly comprising at least one optical component comprising a plurality of waveguides having a predetermined disposition relative to a top surface defined by a substrate of the photonic subassembly, the method comprising:
moving, using a positioning device removably coupled with the FAC, the FAC from a first position, in which the first surface is seated against a second surface of the photonic subassembly, to a second position such that the first surface has a predetermined distance from the second surface, wherein in the second position the fiber array connector is not connected with the photonic subassembly, and wherein in the second position an air gap is defined between the top surface of the substrate and a bottom surface of the FAC;
performing, responsive to moving the FAC to the second position, an active alignment of the plurality of optical fibers with the plurality of waveguides; and
applying, using an application device, an adhesive to form a physical interface between at least two opposing surfaces of the photonic subassembly and the FAC to thereby connect the photonic subassembly with the FAC, wherein the physical interface extends at least partly into the air gap.

10. The method of claim 9, further comprising:
performing, after applying the adhesive, a second active alignment of the plurality of optical fibers with the plurality of waveguides.

11. The method of claim 9, further comprising:
curing the adhesive using a curing device, whereby the fiber array connector is fastened with the photonic subassembly at the physical interface.

12. The method of claim 11, wherein the FAC is transmissive of ultraviolet (UV) light, wherein the curing device comprises an UV light source configured to transmit UV light at least partially through the FAC.

13. The method of claim 9, wherein the second surface comprises one of a side surface of the optical component and a side surface of the substrate.

14-15. (canceled)

16. A non-transitory computer-readable medium comprising computer program code that, when executed by operation of one or more computer processors, performs an operation of connecting a fiber array connector (FAC) with a photonic subassembly,
a plurality of optical fibers coupled with the FAC and extending to a first surface of the FAC, the photonic subassembly comprising at least one optical component comprising a plurality of waveguides having a predetermined disposition relative to a top surface defined by a substrate of the photonic subassembly, the operation comprising:
moving, using a positioning device removably coupled with the FAC, the FAC from a first position, in which the first surface is seated against a second surface of the photonic subassembly, to a second position such that the first surface has a predetermined distance from the second surface, wherein in the second position the fiber array connector is not connected with the photonic subassembly, and wherein in the second position an air gap is defined between the top surface of the substrate and a bottom surface of the FAC;
performing, responsive to moving the FAC to the second position, an active alignment of the plurality of optical fibers with the plurality of waveguides; and
applying, using an application device, an adhesive to form a physical interface between at least two opposing surfaces of the photonic subassembly and the FAC to thereby connect the photonic subassembly with the FAC, wherein the physical interface extends at least partly into the air gap.

17. The computer-readable medium of claim 16, wherein the operation further comprises:
performing, after applying the adhesive, a second active alignment of the plurality of optical fibers with the plurality of waveguides.

18. The computer-readable medium of claim 16, wherein the operation further comprises:
curing the adhesive using a curing device, whereby the fiber array connector is fastened with the photonic subassembly at the physical interface.

19. The computer-readable medium of claim 18, wherein the FAC is transmissive of ultraviolet (UV) light, wherein the curing device comprises an UV light source configured to transmit UV light at least partly through the FAC.

20. (canceled)

21. The apparatus of claim 1, wherein the at least two opposing surfaces comprise the first surface of the fiber array connector and the second surface of the photonic subassembly, and further comprises the top surface of the substrate and a bottom surface of the fiber array connector.

22. The apparatus of claim 21, wherein the adhesive has substantially a same optical index as one or both of (i) the plurality of optical fibers and (ii) the plurality of waveguides, and wherein the physical interface is included in optical paths formed between the plurality of optical fibers and the plurality of waveguides.

23. The apparatus of claim 22, wherein the second surface of the photonic subassembly comprises a side surface of the substrate.

24. The apparatus of claim 23, wherein a side surface of the optical component is not co-planar with the side surface of the substrate.

25. The apparatus of claim 24, wherein the side surface of the optical component is formed using an isotropic etching process, and the side surface of the substrate is formed using a substantially anisotropic etching process.
